(19) United States
(12) Patent Application Publication
(10) Pub. No.: US 2026/0113325 A1
(43) Pub. Date: Apr. 23, 2026

(54) ROUTING MAC ADDRESS MANAGEMENT METHOD AND APPARATUS, ELECTRONIC DEVICE, AND STORAGE MEDIUM

(71) Applicant: SUZHOU METABRAIN INTELLIGENT TECHNOLOGY CO., LTD., Suzhou, Jiangsu (CN)

(72) Inventors: Renzhe SHI, Suzhou, Jiangsu (CN); Xiang CHEN, Suzhou, Jiangsu (CN)

(21) Appl. No.: 19/148,340

(22) PCT Filed: Sep. 26, 2023
(86) PCT No.: PCT/CN2023/121774

§ 371 Date: Jul. 16, 2025

(30) Foreign Application Priority Data
Jan. 20, 2023 (CN) 202310073627.9

(51) Int. Cl. H04L 9/40; H04L 45/00

(52) U.S. Cl. CPC H04L 63/101; H04L 45/54; H04L 45/66

(57) ABSTRACT

The present disclosure discloses a method for managing routing MAC addresses. The method is applied to a switch, the switch includes a routing MAC address management table, and the routing MAC address management table includes hardware table entry resources, the switch is provided with an ACL module, and the method includes: determining whether the hardware table entry resources of the routing MAC address management table meet a preset number of routing interfaces in response to an operation of configuring the routing interfaces; adding a chip routing MAC address management table in response to the hardware table entry resources of the routing MAC address management table meeting the preset number of routing interfaces; and adding one or more routing interfaces according to the ACL module in response to the hardware table entry resources of the routing MAC address management table not meeting the preset number of routing interfaces.

### CROSS-REFERENCE TO RELATED APPLICATION

The present disclosure claims the priority of Chinese patent application filed on Jan. 20, 2023 before the CNIPA, China National Intellectual Property Administration with the application number of 202310073627.9, and the title of “METHOD AND APPARATUS FOR MANAGING ROUTING MAC ADDRESSES, ELECTRONIC DEVICE, AND STORAGE MEDIUM”, which is incorporated herein in its entirety by reference.

### FIELD

Embodiments of the present disclosure relate to the field of Internet technologies, and more particularly to a method for managing routing media access control (MAC) addresses, an apparatus for managing routing MAC addresses, an electronic device and a computer non-transitory readable storage medium.

### BACKGROUND

When existing layer 3 switch devices support layer 3 forwarding features, it is necessary to confirm whether message forwarding is layer 2 forwarding or layer 3 forwarding according to whether a port MAC address is consistent with a message destination MAC address. With an increase in a number of device ports, a number of routing MAC addresses that need to be stored and managed also gradually increases. However, hardware table entry resources of a chip are limited, which leads to a contradiction between user needs with chip resources.

Switching chips used in current mainstream white box switch solutions all have a routing MAC address management table, which is located at a start node of a layer 3 forwarding process of the chip and is used to determine whether the message is a valid layer 3 forwarding message. In white box switches, there are two types of routing interfaces, one is a device physical port, and the other is a virtual layer 3 routing port. For MAC address management of the two types of routing interfaces, the routing MAC address management table of the chip is issued one by one in related art solutions, so that the routing interfaces correspond to the routing MAC address management table of the chip one by one.

Specifications of the routing MAC address management table of the switching chips used in the current mainstream white box switch solutions are all around 2,000, however, a user has a demand for a number of routing interfaces has reached about 4,000. If the management is performed according to the traditional one-to-one management method of the routing interfaces and the routing MAC address management table of the chip, the number of routing interfaces has been limited by hardware resources, which leads to the failure to meet configuration requirements of the user.

### SUMMARY

Embodiments of the present disclosure provide a method and an apparatus for managing routing MAC addresses, an electronic device and a computer non-transitory readable storage medium, so as to solve or partially solve the problem that the number of routing interfaces has been limited by the hardware resources of the routing MAC address management table of a switch in the related art, which leads to the failure to meet configuration requirements of the user.

The embodiments of the present disclosure disclose a method for managing routing media access control (MAC) addresses, applied to a switch, where the switch includes a routing MAC address management table, and the routing MAC address management table includes hardware table entry resources, where the switch is provided with an access control list (ACL) module, and the method includes:
determining whether the hardware table entry resources of the routing MAC address management table meet a preset number of routing interfaces in response to an operation of configuring the routing interfaces;
adding a chip routing MAC address management table in response to the hardware table entry resources of the routing MAC address management table meeting the preset number of routing interfaces; and
adding one or more routing interfaces according to the ACL module in response to the hardware table entry resources of the routing MAC address management table not meeting the preset number of routing interfaces.

In some embodiments, adding the one or more routing interfaces according to the ACL module in response to the hardware table entry resources of the routing MAC address management table not meeting the preset number of routing interfaces includes:
determining an interface type of the routing interfaces; and
adding the one or more routing interfaces corresponding to the interface type according to the interface type.

In some embodiments, the interface type of the routing interfaces includes a physical routing interface, and adding the one or more routing interfaces corresponding to the interface type according to the interface type includes:
adding the one or more routing interfaces with the interface type of the physical routing interface through the ACL module in response to the interface type of the routing interfaces being the physical routing interface.

In some embodiments, the interface type of the routing interfaces includes a virtual routing interface, and adding the one or more routing interfaces corresponding to the interface type according to the interface type includes:
adding the one or more routing interfaces with the interface type of the virtual routing interface according to the interface type in response to the interface type of the routing interfaces being the virtual routing interface.

In some embodiments, the switch is configured to forward a message, and a forwarding type of the message includes layer 2 forwarding and layer 3 forwarding.

In some embodiments, the routing MAC address management table on the switch is configured to determine whether the message is a valid layer 3 forwarding message.

In some embodiments, the routing MAC address management table includes routing MAC addresses, and the method further includes:
determining the forwarding type of the message to perform corresponding forwarding on the message according to a relationship between the routing MAC addresses with a message destination MAC address corresponding to a message to be forwarded.

In some embodiments, determining the forwarding type of the message to perform corresponding forwarding on the message according to the relationship between the routing MAC addresses with the message destination MAC address corresponding to the message to be forwarded includes:
performing, by the switch, layer 3 forwarding on the message in response to the routing MAC address being consistent with the message destination MAC address corresponding to the message to be forwarded; and
performing, by the switch, layer 2 forwarding on the message in response to the routing MAC address being inconsistent with the message destination MAC address corresponding to the message to be forwarded.

In some embodiments, the switch includes an ingress port number, and the method further includes:
determining a relationship between a port number on the switch and the message destination MAC address corresponding to the message to be forwarded, and determining the forwarding type of the message in response to adding the one or more routing interfaces with the interface type of the physical routing interface through the ACL module.

In some embodiments, determining the relationship between the port number on the switch and the message destination MAC address corresponding to the message to be forwarded, and determining the forwarding type of the message in response to adding the one or more routing interfaces with the interface type of the physical routing interface through the ACL module includes:
performing, by the switch, layer 3 forwarding on the message in response to the port number on the switch being consistent with the message destination MAC address corresponding to the message to be forwarded; and
performing, by the switch, layer 2 forwarding on the message in response to the port number on the switch being inconsistent with the message destination MAC address corresponding to the message to be forwarded.

In some embodiments, the method further includes:
determining a relationship between a message virtual local area network (VLAN) corresponding to the message to be forwarded and the message destination MAC address, and determining the forwarding type of the message in response to adding the one or more routing interfaces with the interface type of the virtual routing interface through the ACL module.

In some embodiments, determining the relationship between a message virtual local area network (VLAN) corresponding to the message to be forwarded and the message destination MAC address, and determining the forwarding type of the message in response to adding the one or more routing interfaces with the interface type of the virtual routing interface through the ACL module includes:
performing, by the switch, layer 3 forwarding on the message in response to the message VLAN corresponding to the message to be forwarded being consistent with the message destination MAC address; and
performing, by the switch, layer 2 forwarding on the message in response to the message VLAN corresponding to the message to be forwarded being inconsistent with the message destination MAC address.

In some embodiments, the switch includes software for controlling hardware in the switch, and the method further includes:
issuing, by the software, the routing MAC address management table to the hardware in response to adding the one or more routing interfaces; and
creating, by the software, an ACL table for the ACL module and issuing to the hardware, and creating a soft linked list in response to the hardware table entry resources of the routing MAC address management table not meeting the preset number of routing interfaces.

In some embodiments, the soft linked list is configured to manage the ACL table.

In some embodiments, the method further includes:
confirming whether routing MAC addresses of the one or more routing interfaces to be deleted are stored in the ACL table according to the soft linked list to obtain a matching result in response to deleting the one or more routing interfaces; and
processing the one or more routing interfaces according to the matching result.

In some embodiments, processing the one or more routing interfaces according to the matching result includes:
deleting the soft linked list corresponding to the ACL table in response to the routing MAC addresses of the one or more routing interfaces to be deleted being stored in the ACL table; and
searching the routing MAC addresses of the one or more routing interfaces to be deleted from the routing MAC address management table to delete the routing MAC addresses of the one or more routing interfaces in response to the routing MAC addresses of the one or more routing interfaces to be deleted being not stored in the ACL table.

In some embodiments, the method further includes:
transferring a header of the soft linked list corresponding to the ACL table to the routing MAC address management table in response to deleting the routing MAC addresses of the one or more routing interfaces.

In some embodiments, each of the routing interfaces is an index in the routing MAC address management table, and the routing interface is in a one-to-one correspondence with the chip routing MAC address management table.

The embodiments of the present disclosure further disclose an apparatus for managing routing media access control (MAC) addresses, applied to a switch, where the switch includes a routing MAC address management table, and the routing MAC address management table includes hardware table entry resources, where the switch is provided with an access control list (ACL) module, and the apparatus includes:
a hardware table entry resource number determining module configured to determine whether the hardware table entry resources of the routing MAC address management table meet a preset number of routing interfaces in response to an operation of configuring the routing interfaces;
a chip routing MAC address management table adding module configured to add a chip routing MAC address management table in response to the hardware table entry resources of the routing MAC address management table meeting the preset number of routing interfaces; and
a routing interface adding module configured to add one or more routing interfaces according to the ACL module in response to the hardware table entry resources of the routing MAC address management table not meeting the preset number of routing interfaces.

In some embodiments, the routing interface adding module is specifically configured to:
determine an interface type of the routing interfaces; and
add the one or more routing interfaces corresponding to the interface type according to the interface type.

In some embodiments, the interface type of the routing interfaces includes a physical routing interface, and the apparatus further includes:
adding the one or more routing interfaces with the interface type of the physical routing interface through the ACL module in response to the interface type of the routing interfaces being the physical routing interface.

In some embodiments, the interface type of the routing interfaces includes a virtual routing interface, and the apparatus further includes:
adding the one or more routing interfaces with the interface type of the virtual routing interface according to the interface type in response to the interface type of the routing interfaces being the virtual routing interface.

In some embodiments, the routing MAC address management table includes routing MAC addresses, and the apparatus further includes:
determining the forwarding type of the message to perform corresponding forwarding on the message according to a relationship between the routing MAC addresses with a message destination MAC address corresponding to a message to be forwarded.

In some embodiments, the apparatus further includes:
performing, by the switch, layer 3 forwarding on the message in response to the routing MAC address being consistent with the message destination MAC address corresponding to the message to be forwarded; and
performing, by the switch, layer 2 forwarding on the message in response to the routing MAC address being inconsistent with the message destination MAC address corresponding to the message to be forwarded.

In some embodiments, the switch includes an ingress port number, and the apparatus further includes:
determining a relationship between a port number on the switch and the message destination MAC address corresponding to the message to be forwarded, and determining the forwarding type of the message in response to adding the one or more routing interfaces with the interface type of the physical routing interface through the ACL module.

In some embodiments, the apparatus further includes:
performing, by the switch, layer 3 forwarding on the message in response to the port number on the switch being consistent with the message destination MAC address corresponding to the message to be forwarded; and
performing, by the switch, layer 2 forwarding on the message in response to the port number on the switch being inconsistent with the message destination MAC address corresponding to the message to be forwarded.

In some embodiments, the apparatus further includes:
determining a relationship between a message virtual local area network (VLAN) corresponding to the message to be forwarded and the message destination MAC address, and determining the forwarding type of the message in response to adding the one or more routing interfaces with the interface type of the virtual routing interface through the ACL module.

In some embodiments, the apparatus further includes:
performing, by the switch, layer 3 forwarding on the message in response to the message VLAN corresponding to the message to be forwarded being consistent with the message destination MAC address; and
performing, by the switch, layer 2 forwarding on the message in response to the message VLAN corresponding to the message to be forwarded being inconsistent with the message destination MAC address.

In some embodiments, the switch includes software for controlling hardware in the switch, and the apparatus further includes:
issuing, by the software, the routing MAC address management table to the hardware in response to adding the one or more routing interfaces; and
creating, by the software, an ACL table for the ACL module and issuing to the hardware, and creating a soft linked list in response to the hardware table entry resources of the routing MAC address management table not meeting the preset number of routing interfaces.

In some embodiments, the apparatus further includes:
confirming whether routing MAC addresses of the one or more routing interfaces to be deleted are stored in the ACL table according to the soft linked list to obtain a matching result in response to deleting the one or more routing interfaces; and
processing the one or more routing interfaces according to the matching result.

In some embodiments, the apparatus further includes:
deleting the soft linked list corresponding to the ACL table in response to the routing MAC addresses of the one or more routing interfaces to be deleted being stored in the ACL table; and
searching the routing MAC addresses of the one or more routing interfaces to be deleted from the routing MAC address management table to delete the routing MAC addresses of the one or more routing interfaces in response to the routing MAC addresses of the one or more routing interfaces to be deleted being not stored in the ACL table.

In some embodiments, the apparatus further includes:
transferring a header of the soft linked list corresponding to the ACL table to the routing MAC address management table in response to deleting the routing MAC addresses of the one or more routing interfaces.

The embodiments of the present disclosure further disclose an electronic device, including: a processor, a communication interface, a memory and a communication bus, where the processor, the communication interface and the memory communicate with each other through the communication bus;
the memory is configured to store computer programs; and
the processor is configured to implement the method according to the embodiments of the present disclosure when executing the computer programs stored on the memory.

The embodiments of the present disclosure further disclose a computer non-transitory readable storage medium having instructions stored thereon, where the instructions, when executed by one or more processors, cause the processors to perform the method according to the embodiments of the present disclosure.

The embodiments of the present disclosure include following advantages.

In embodiments of the present disclosure, the method is applied to the switch, the switch includes the routing MAC address management table, and the routing MAC address management table includes hardware table entry resources, where the switch is provided with the ACL module, it is determined whether the hardware table entry resources of the routing MAC address management table meet the preset number of routing interfaces in response to the operation of configuring the routing interfaces; the chip routing MAC address management table is added in response to the hardware table entry resources of the routing MAC address management table meeting the preset number of routing interfaces; and one or more routing interfaces are added according to the ACL module in response to the hardware table entry resources of the routing MAC address management table not meeting the preset number of routing interfaces. In the embodiments of the present disclosure, when configuring the routing interfaces, by adding the chip routing MAC address management table and adding the routing interfaces according to the ACL module, that is, by using the forwarding chip with the existing specifications and combining the function of the chip ACL, the number of devices supporting the routing interfaces of the switch is expanded, and the user's usage requirements for the layer 3 routing interface of the switch is met to the maximum extent.

### BRIEF DESCRIPTION OF THE DRAWINGS

FIG. 1 is a flowchart of steps of a method for managing routing MAC addresses provided in an embodiment of the present disclosure.

FIG. 2 is a schematic flowchart of managing routing MAC addresses provided in an embodiment of the present disclosure.

FIG. 3 is a schematic flowchart of adjusting a routing MAC address management table and an ACL table provided in an embodiment of the present disclosure.

FIG. 4 is a block diagram of a structure of an apparatus for managing routing MAC addresses provided in an embodiment of the present disclosure.

FIG. 5 is a schematic structural diagram of a computer non-transitory readable storage medium provided in an embodiment of the present disclosure.

FIG. 6 is a schematic diagram of a hardware structure of an electronic device for implementing various embodiments of the present disclosure.

### DETAILED DESCRIPTION

In order to make the objectives, features, and advantages of the present disclosure more obvious and easy to understand, the present disclosure will be described in further detail below with reference to the accompanying drawings and specific embodiments.

In order to make a person skilled in the art better understand technical solutions of embodiments of the present disclosure, some technical features involved in the embodiments of the present disclosure are explained and illustrated below.

Access control lists (ACL), which are a common function of switches, can control various behaviors of messages and plays an important role in a message processing pipeline of switching chips. Specifically, the ACL is an access control technology based on packet filtering, which can filter packets on an interface according to set conditions, and allow the packets to pass or be discarded. The access control lists are widely applied to routers and layer 3 switches, and access of a user to a network can be effectively controlled by means of the access control lists, thereby ensuring network security to the maximum extent.

Virtual local area network (VLAN) is a group of logic devices and users, and these devices and users are not restricted by their physical locations, and may be organized based on a factor such as a function, a department, or an application. Communication between these devices and users seems like that these devices and users are in a same network segment. The VLAN can provide a virtual network topology framework that conforms to the business structure for information services and sub-services, as well as information services, and realize access control functions. Compared with traditional local area network technologies, VLAN technologies are more flexible.

As an example, when managing routing MAC addresses of switches, for MAC address management of the two types of routing interfaces, the routing MAC address management table of the chip is issued one by one in related art solutions, so that the routing interfaces correspond to the routing MAC address management table of the chip one by one. Specifications of the routing MAC address management table of the switching chips used in the current mainstream white box switch solutions are all around 2,000, however, a user has a demand for a number of routing interfaces has reached about 4,000. If the management is performed according to the traditional one-to-one management method of the routing interfaces and the routing MAC address management table of the chip, the number of routing interfaces has been limited by hardware resources, which leads to the failure to meet configuration requirements of the user.

In this regard, one of core application points of the present disclosure is that the method is applied to a switch, the switch includes a routing MAC address management table, and the routing MAC address management table includes hardware table entry resources, where the switch is provided with an access control list (ACL) module, it is determined whether the hardware table entry resources of the routing MAC address management table meet a preset number of routing interfaces in response to an operation of configuring the routing interfaces; a chip routing MAC address management table is added in response to the hardware table entry resources of the routing MAC address management table meeting the preset number of routing interfaces; and one or more routing interfaces are added according to the ACL module in response to the hardware table entry resources of the routing MAC address management table not meeting the preset number of routing interfaces. In the embodiments of the present disclosure, when configuring the routing interfaces, by adding the chip routing MAC address management table and adding the routing interfaces according to the ACL module, that is, by using the forwarding chip with the existing specifications and combining the function of the chip ACL, the number of devices supporting the routing interfaces of the switch is expanded, and the user's usage requirements for the layer 3 routing interface of the switch is met to the maximum extent.

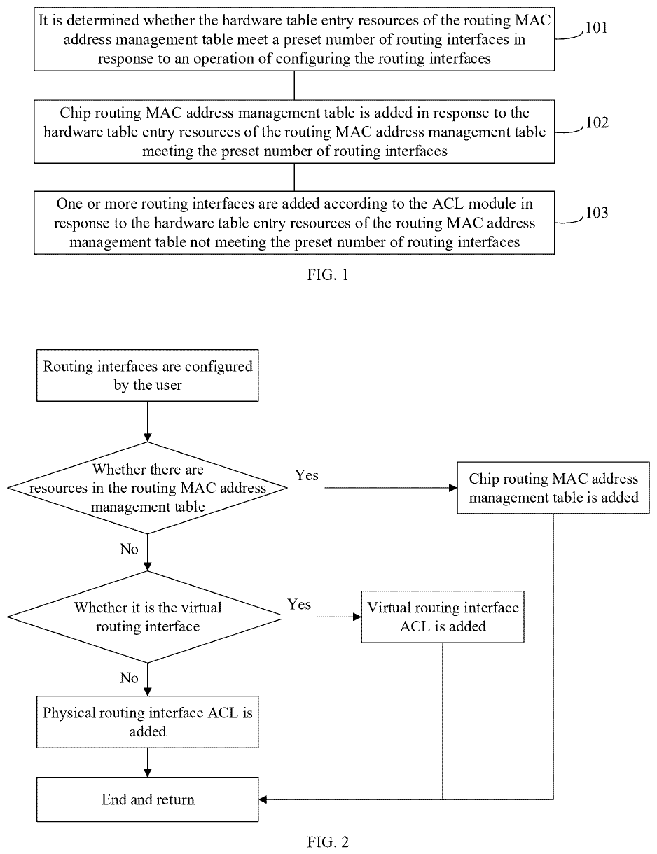

Referring to FIG. 1, FIG. 1 is a flowchart of steps of a method for managing routing MAC addresses provided in an embodiment of the present disclosure. The method is applied to a switch, where the switch includes a routing MAC address management table, and the routing MAC address management table includes hardware table entry resources, where the switch is provided with an access control list (ACL) module, and the method can specifically include following steps.

Step 101, it is determined whether the hardware table entry resources of the routing MAC address management table meet a preset number of routing interfaces in response to an operation of configuring the routing interfaces.

In the embodiment of the present disclosure, the switch mainly adopts a layer 3 switch, which can support a routing function and can be used to forward a message. In the layer 3 switch, a forwarding type of the message can include layer 2 forwarding and layer 3 forwarding, that is, the layer 3 switch can be used to perform layer 2 forwarding and layer 3 forwarding on the message. When the routing MAC address is consistent with the message destination MAC address corresponding to the message to be forwarded, the switch performs layer 3 forwarding on the message; and when the routing MAC address is inconsistent with the message destination MAC address corresponding to the message to be forwarded, the switch performs layer 2 forwarding on the message.

The message (packet) is a data unit exchanged and transmitted in a network, that is, a data block to be sent by a site at one time. The message includes complete data information to be sent. The lengths of messages are not the same, are not limited, and are variable. It can be understood that the message can be data sent by a device connected to a switch to another device through the switch.

The MAC address is a unique network identifier of a device, and can be bound in a router to restrict devices logging into the router. The routing MAC address is a MAC address in the layer 3 switch. There are multiple ports in the layer 3 switch, and each of the multiple ports can correspond to a port MAC address, and thus the routing MAC address can include the port MAC address.

The routing MAC address management table is a software table entry in the software of the switch used to control a chip routing MAC address management table, and can be used to determine whether a message is a valid layer 3 forwarding message, where the routing MAC address management table includes hardware table entry resources.

The hardware table entry resources are table entry resources for chips in switches, and can correspond to the routing MAC addresses. The ACL module can also be called an access control list module. The ACL module can control message forwarding and support layer 3 forwarding by layer 3 switches. The access control lists can filter packets on an interface according to set conditions, and allow the packets to pass or be discarded. The access control lists are widely applied to routers and layer 3 switches, and access of a user to a network can be effectively controlled by means of the access control lists, thereby ensuring network security to the maximum extent.

The routing interface can be understood as an index in the routing MAC address management table. The routing interface is in a one-to-one correspondence with the chip routing MAC address management table. Specifically, each routing interface can correspond to a table entry resource in the chip routing MAC address management table.

The preset number is a number of routing interfaces manually set, a person skilled in the art can set the preset number according to actual situations, and the embodiment of the present disclosure does not limit this.

In the embodiment of the present disclosure, the switch includes the routing MAC address management table, and the routing MAC address management table includes hardware table entry resources, where the switch is provided with the ACL module, in response to the operation of configuring the routing interfaces, it is determined whether the hardware table entry resources of the routing MAC address management table meet the preset number of routing interfaces, so that routing MAC addresses may be managed according to the matching result.

Step 102, a chip routing MAC address management table is added in response to the hardware table entry resources of the routing MAC address management table meeting the preset number of routing interfaces.

The chip routing MAC address management table is the hardware table entry resource in the switching chip of the switch, and can be in a one-to-one correspondence with the routing interface. Specifically, each routing interface can correspond to a table entry resource in the chip routing MAC address management table.

In the embodiment of the present disclosure, in response to the operation of configuring the routing interfaces, it is determined whether the hardware table entry resources of the routing MAC address management table meet the preset number of routing interfaces; if the hardware table entry resources of the routing MAC address management table meet the preset number of routing interfaces, the chip routing MAC address management table is added.

Step 103, one or more routing interfaces are added according to the ACL module in response to the hardware table entry resources of the routing MAC address management table not meeting the preset number of routing interfaces.

In the embodiment, in response to the operation of configuring the routing interfaces, it is determined whether the hardware table entry resources of the routing MAC address management table meet the preset number of routing interfaces; if the hardware table entry resources of the routing MAC address management table do not meet the preset number of routing interfaces, one or more routing interfaces are added according to the ACL module, and thus the number of devices supporting the routing interfaces of the switch is expanded, and the user's usage requirements for the layer 3 routing interface of the switch is met to the maximum extent.

In embodiments of the present disclosure, the method is applied to the switch, the switch includes the routing MAC address management table, and the routing MAC address management table includes hardware table entry resources, where the switch is provided with the ACL module, it is determined whether the hardware table entry resources of the routing MAC address management table meet the preset number of routing interfaces in response to the operation of configuring the routing interfaces; the chip routing MAC address management table is added in response to the hardware table entry resources of the routing MAC address management table meeting the preset number of routing interfaces; and one or more routing interfaces are added according to the ACL module in response to the hardware table entry resources of the routing MAC address management table not meeting the preset number of routing interfaces. In the embodiments of the present disclosure, when configuring the routing interfaces, by adding the chip routing MAC address management table and adding the routing interfaces according to the ACL module, that is, by using the forwarding chip with the existing specifications and combining the function of the chip ACL, the number of devices supporting the routing interfaces of the switch is expanded, and the user's usage requirements for the layer 3 routing interface of the switch is met to the maximum extent.

In one embodiment, step 103, adding the one or more routing interfaces according to the ACL module in response to the hardware table entry resources of the routing MAC address management table not meeting the preset number of routing interfaces includes:
determining an interface type of the routing interfaces; and
adding the one or more routing interfaces corresponding to the interface type according to the interface type.

The MAC address is a unique network identifier of a device, and can be bound in a router to restrict devices logging into the router. The routing MAC address is a MAC address in the layer 3 switch. There are multiple ports in the layer 3 switch, and each of the multiple ports can correspond to a port MAC address, and thus the routing MAC address can include the port MAC address. The routing MAC address management table is a software table entry in the software of the switch used to control a chip routing MAC address management table, and can be used to determine whether a message is a valid layer 3 forwarding message, where the routing MAC address management table includes hardware table entry resources.

The hardware table entry resources are table entry resources for chips in switches, and can correspond to the routing MAC addresses. The ACL module can also be called an access control list module. The ACL module can control message forwarding and support layer 3 forwarding by layer 3 switches. The access control lists can filter packets on an interface according to set conditions, and allow the packets to pass or be discarded. The access control lists are widely applied to routers and layer 3 switches, and access of a user to a network can be effectively controlled by means of the access control lists, thereby ensuring network security to the maximum extent.

The routing interface can be understood as an index in the routing MAC address management table. The routing interface is in a one-to-one correspondence with the chip routing MAC address management table. Specifically, each routing interface can correspond to a table entry resource in the chip routing MAC address management table.

The preset number is a number of routing interfaces manually set, a person skilled in the art can set the preset number according to actual situations, and the embodiment of the present disclosure does not limit this.

The interface type mainly includes two types of routing interfaces stored in switches, namely, a physical routing interface and a virtual routing interface. Specifically, one is a device physical port, and the other is a virtual layer 3 routing port, in which MAC addresses of the two types of routing interfaces are mainly managed.

In some embodiments, when the interface type of the routing interfaces is the physical routing interface, the one or more routing interfaces with the interface type of the physical routing interface are added through the ACL module; and when the interface type of the routing interfaces is the virtual routing interface, the one or more routing interfaces with the interface type of the virtual routing interface are added according to the interface type.

Referring to FIG. 2, FIG. 2 is a schematic flowchart of managing routing MAC addresses provided in an embodiment of the present disclosure. As shown in FIG. 2, when configuring one or more routing interfaces of a switch, a user first determines whether hardware table entry resources of a routing MAC address management table can meet a preset number of routing interfaces set by the user. If the hardware table entry resources of the routing MAC address management table meet the preset number of routing interfaces, a chip routing MAC address management table is added; and if the hardware table entry resources of the routing MAC address management table do not meet the preset number of routing interfaces, it is determined an interface type of the routing interfaces. When the interface type of the routing interfaces is a physical routing interface, the one or more routing interfaces with the interface type of the physical routing interface are added through the ACL module; and when the interface type of the routing interfaces is a virtual routing interface, the one or more routing interfaces with the interface type of the virtual routing interface are added according to the interface type. When configuring the routing interfaces, by adding the chip routing MAC address management table and adding the routing interfaces according to the ACL module, that is, by using the forwarding chip with the existing specifications and combining the function of the chip ACL, the number of devices supporting the routing interfaces of the switch is expanded, and the user's usage requirements for the layer 3 routing interface of the switch is met to the maximum extent.

In one example, assuming that the routing MAC address management table can support 2000 routing interfaces. After adding the ACL module, the routing MAC address management table can support 4000 virtual routing interfaces and 30 physical routing interfaces. Specifically, when a user creates 4000 virtual routing interfaces, a device uses a full specification routing MAC address management table (2000), and at the same time, 2000 virtual routing interfaces can be created through the ACL module, and the user's layer 3 service forwarding function can be supported. In another example, assuming that the user has created 2000 virtual routing interfaces and 20 physical routing interfaces, the device uses the full specification routing MAC address management table (2000), and at the same time, 20 physical routing interfaces can be created through the ACL module, and the user's layer 3 service forwarding function can be supported. When configuring the routing interfaces, by adding the chip routing MAC address management table and adding the routing interfaces according to the ACL module, that is, by using the forwarding chip with the existing specifications and combining the function of the chip ACL, the number of devices supporting the routing interfaces of the switch is expanded, and the user's usage requirements for the layer 3 routing interface of the switch is met to the maximum extent.

In some embodiments, when adding the one or more routing interfaces with the interface type of the physical routing interface through the ACL module, a relationship between a port number on the switch and the message destination MAC address corresponding to the message to be forwarded is determined, and the forwarding type of the message is determined. When the port number on the switch is consistent with the message destination MAC address corresponding to the message to be forwarded, the switch performs layer 3 forwarding on the message; and when the port number on the switch is inconsistent with the message destination MAC address corresponding to the message to be forwarded, the switch performs layer 2 forwarding on the message. It can be understood that when the routing interfaces with the interface type of the physical routing interface are added through the ACL module, a rule for configuring the routing interfaces of the ACL is to match the message destination MAC address corresponding to the message to be forwarded through the port number on the switch.

In some embodiments, when adding the one or more routing interfaces with the interface type of the virtual routing interface through the ACL module, a relationship between a message virtual local area network (VLAN) corresponding to the message to be forwarded and the message destination MAC address is determined, and the forwarding type of the message is determined. When the message VLAN corresponding to the message to be forwarded is consistent with the message destination MAC address, the switch performs layer 3 forwarding on the message; and when the message VLAN corresponding to the message to be forwarded is inconsistent with the message destination MAC address, the switch performs layer 2 forwarding on the message. It can be understood that when the routing interfaces with the interface type of the virtual routing interface are added through the ACL module, a rule for configuring the routing interfaces of the ACL is to match the message destination MAC address through the message VLAN corresponding to the message to be forwarded.

In the embodiment of the present disclosure, when configuring one or more routing interfaces of a switch, a user first determines whether hardware table entry resources of a routing MAC address management table can meet a preset number of routing interfaces set by the user. If the hardware table entry resources of the routing MAC address management table meet the preset number of routing interfaces, a chip routing MAC address management table is added; and if the hardware table entry resources of the routing MAC address management table do not meet the preset number of routing interfaces, it is determined an interface type of the routing interfaces. When the interface type of the routing interfaces is a physical routing interface, the one or more routing interfaces with the interface type of the physical routing interface are added through the ACL module; and when the interface type of the routing interfaces is a virtual routing interface, the one or more routing interfaces with the interface type of the virtual routing interface are added according to the interface type. When configuring the routing interfaces, by adding the chip routing MAC address management table and adding the routing interfaces according to the ACL module, that is, by using the forwarding chip with the existing specifications and combining the function of the chip ACL, the number of devices supporting the routing interfaces of the switch is expanded, and the user's usage requirements for the layer 3 routing interface of the switch is met to the maximum extent.

In one embodiment, the routing MAC address management table includes routing MAC addresses, and the method further includes:
determining the forwarding type of the message to perform corresponding forwarding on the message according to a relationship between the routing MAC addresses with a message destination MAC address corresponding to a message to be forwarded.

In some embodiments, performing, by the switch, layer 3 forwarding on the message in response to the routing MAC address being consistent with the message destination MAC address corresponding to the message to be forwarded; and performing, by the switch, layer 2 forwarding on the message in response to the routing MAC address being inconsistent with the message destination MAC address corresponding to the message to be forwarded.

The forwarding type can include layer 2 forwarding and layer 3 forwarding, that is, the layer 3 switch can be used to perform layer 2 forwarding and layer 3 forwarding on the message. When the routing MAC address is consistent with the message destination MAC address corresponding to the message to be forwarded, the switch performs layer 3 forwarding on the message; and when the routing MAC address is inconsistent with the message destination MAC address corresponding to the message to be forwarded, the switch performs layer 2 forwarding on the message. It should be noted that this is the forwarding of the message without adding the ACL module.

The message (packet) is a data unit exchanged and transmitted in a network, that is, a data block to be sent by a site at one time. The message includes complete data information to be sent. The lengths of messages are not the same, are not limited, and are variable. It can be understood that the message can be data sent by a device connected to a switch to another device through the switch.

The MAC address is a unique network identifier of a device, and can be bound in a router to restrict devices logging into the router. The routing MAC address is a MAC address in the layer 3 switch. There are multiple ports in the layer 3 switch, and each of the multiple ports can correspond to a port MAC address, and thus the routing MAC address can include the port MAC address.

The routing MAC address management table is a software table entry in the software of the switch used to control a chip routing MAC address management table, and can be used to determine whether a message is a valid layer 3 forwarding message, where the routing MAC address management table includes hardware table entry resources.

In some embodiments, when adding the one or more routing interfaces with the interface type of the physical routing interface through the ACL module, a relationship between a port number on the switch and the message destination MAC address corresponding to the message to be forwarded is determined, and the forwarding type of the message is determined. When the port number on the switch is consistent with the message destination MAC address corresponding to the message to be forwarded, the switch performs layer 3 forwarding on the message; and when the port number on the switch is inconsistent with the message destination MAC address corresponding to the message to be forwarded, the switch performs layer 2 forwarding on the message. It can be understood that when the routing interfaces with the interface type of the physical routing interface are added through the ACL module, a rule for configuring the routing interfaces of the ACL is to match the message destination MAC address corresponding to the message to be forwarded through the port number on the switch. Configuration operations of the ACL can change the message forwarding to layer 3 forwarding.

In some embodiments, when adding the one or more routing interfaces with the interface type of the virtual routing interface through the ACL module, a relationship between a message virtual local area network (VLAN) corresponding to the message to be forwarded and the message destination MAC address is determined, and the forwarding type of the message is determined. When the message VLAN corresponding to the message to be forwarded is consistent with the message destination MAC address, the switch performs layer 3 forwarding on the message; and when the message VLAN corresponding to the message to be forwarded is inconsistent with the message destination MAC address, the switch performs layer 2 forwarding on the message. It can be understood that when the routing interfaces with the interface type of the virtual routing interface are added through the ACL module, a rule for configuring the routing interfaces of the ACL is to match the message destination MAC address through the message VLAN corresponding to the message to be forwarded. Configuration operations of the ACL can change the message forwarding to layer 3 forwarding.

In one embodiment, the switch includes software for controlling hardware in the switch, and the method further includes:
issuing, by the software, the routing MAC address management table to the hardware in response to adding the one or more routing interfaces; and
creating, by the software, an ACL table for the ACL module and issuing to the hardware, and creating a soft linked list in response to the hardware table entry resources of the routing MAC address management table not meeting the preset number of routing interfaces.

The ACL table can be used to store routing MAC addresses, and the soft linked list can be used to manage the ACL table.

In some embodiments, when the one or more routing interfaces need to be deleted, it can be confirmed whether routing MAC addresses of the one or more routing interfaces to be deleted are stored in the ACL table according to the soft linked list. If the routing MAC addresses of the one or more routing interfaces to be deleted are stored in the ACL table, the soft linked list corresponding to the ACL table can be deleted; and if the routing MAC addresses of the one or more routing interfaces to be deleted are not stored in the ACL table, the routing MAC addresses of the one or more routing interfaces to be deleted is searched from the routing MAC address management table to delete the routing MAC addresses of the one or more routing interfaces, and at the same time, a header of the soft linked list corresponding to the ACL table is transferred to the routing MAC address management table.

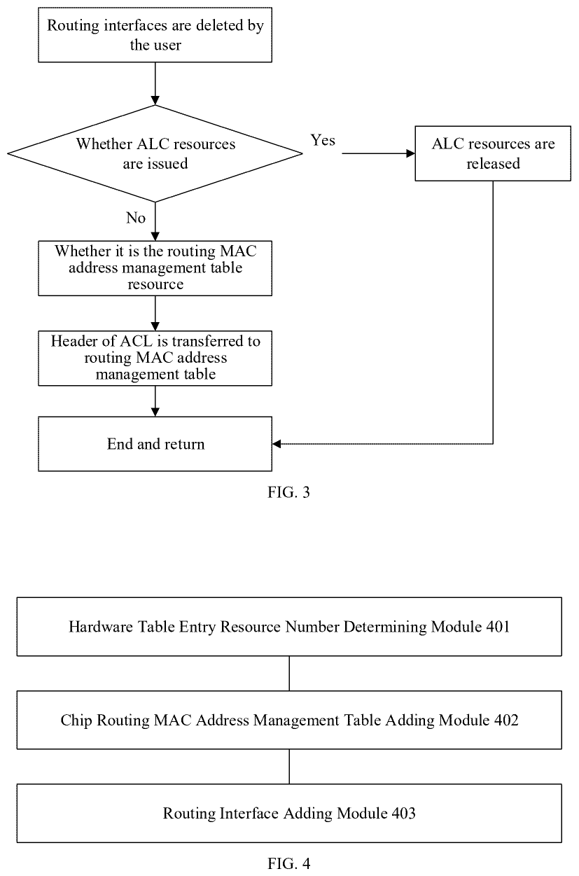

Referring to FIG. 3, FIG. 3 is a schematic flowchart of adjusting a routing MAC address management table and an ACL table provided in an embodiment of the present disclosure. As shown in FIG. 3, in a process of adding a routing interface by a user, upper software in the switch issues a limited routing MAC address management table to hardware. When the routing MAC address management table is full, that is, when hardware table entry resources in the routing MAC address management table are exhausted, the software creates an ACL table entry and issues the ACL table entry to the hardware, and at the same time a soft linked list is created for managing the ACL table entry. In a process of deleting a routing interface, firstly, it is necessary to search the soft linked list to confirm whether a MAC address of a routing interface to be deleted is issued in the ACL table. If the MAC address of the routing interface to be deleted is in the issued ACL table, a soft linked list corresponding to the ACL table is deleted to release the resources in the ACL table; and if the MAC address of the routing interface to be deleted is not in the issued ACL table, the MAC address of the routing interface to be deleted is searched from the routing MAC address management table for deletion, and at the same time, a header of the soft linked list in the ACL table is transferred to the routing MAC address management table, so that the resources in the routing MAC address management table and the ACL table may be dynamically adjusted and the routing MAC address may be effectively managed.

In embodiments of the present disclosure, the method is applied to a switch, the switch includes a routing MAC address management table, and the routing MAC address management table includes hardware table entry resources, where the switch is provided with an access control list (ACL) module, it is determined whether the hardware table entry resources of the routing MAC address management table meet a preset number of routing interfaces in response to an operation of configuring the routing interfaces; a chip routing MAC address management table is added in response to the hardware table entry resources of the routing MAC address management table meeting the preset number of routing interfaces; and one or more routing interfaces are added according to the ACL module in response to the hardware table entry resources of the routing MAC address management table not meeting the preset number of routing interfaces. In the embodiments of the present disclosure, when configuring the routing interfaces, by adding the chip routing MAC address management table and adding the routing interfaces according to the ACL module, that is, by using the forwarding chip with the existing specifications and combining the function of the chip ACL, the number of devices supporting the routing interfaces of the switch is expanded, and the user's usage requirements for the layer 3 routing interface of the switch is met to the maximum extent.

It should be noted that for the sake of simplicity, the method embodiments are described as a series of action combinations. However, a person skilled in the art should be aware that the embodiments of the present disclosure are not limited by the order of the described actions, as certain steps may be performed in other orders or simultaneously according to the embodiments of the present disclosure. Secondly, a person skilled in the art should also be aware that the embodiments described in the specification are preferred embodiments, and the actions involved are not necessarily necessary for the embodiments of the present disclosure.

Referring to FIG. 4, FIG. 4 is a block diagram of a structure of an apparatus for managing routing MAC addresses provided in an embodiment of the present disclosure. The apparatus is applied to a switch, where the switch includes a routing MAC address management table, and the routing MAC address management table includes hardware table entry resources, where the switch is provided with an access control list (ACL) module, and the apparatus can specifically include following modules:
a hardware table entry resource number determining module 401 configured to determine whether the hardware table entry resources of the routing MAC address management table meet a preset number of routing interfaces in response to an operation of configuring the routing interfaces;
a chip routing MAC address management table adding module 402 configured to add a chip routing MAC address management table in response to the hardware table entry resources of the routing MAC address management table meeting the preset number of routing interfaces; and
a routing interface adding module 403 configured to add one or more routing interfaces according to the ACL module in response to the hardware table entry resources of the routing MAC address management table not meeting the preset number of routing interfaces.

In one embodiment, the routing interface adding module 403 is specifically configured to:
determine an interface type of the routing interfaces; and
add the one or more routing interfaces corresponding to the interface type according to the interface type.

In one embodiment, the interface type of the routing interfaces includes a physical routing interface, and the apparatus further includes:
adding the one or more routing interfaces with the interface type of the physical routing interface through the ACL module in response to the interface type of the routing interfaces being the physical routing interface.

In one embodiment, the interface type of the routing interfaces includes a virtual routing interface, and the apparatus further includes:
adding the one or more routing interfaces with the interface type of the virtual routing interface according to the interface type in response to the interface type of the routing interfaces being the virtual routing interface.

In one embodiment, the routing MAC address management table includes routing MAC addresses, and the apparatus further includes:
determining the forwarding type of the message to perform corresponding forwarding on the message according to a relationship between the routing MAC addresses with a message destination MAC address corresponding to a message to be forwarded.

In one embodiment, the apparatus further includes:
performing, by the switch, layer 3 forwarding on the message in response to the routing MAC address being consistent with the message destination MAC address corresponding to the message to be forwarded; and
performing, by the switch, layer 2 forwarding on the message in response to the routing MAC address being inconsistent with the message destination MAC address corresponding to the message to be forwarded.

In one embodiment, the switch includes an ingress port number, and the apparatus further includes:
determining a relationship between a port number on the switch and the message destination MAC address corresponding to the message to be forwarded, and determining the forwarding type of the message in response to adding the one or more routing interfaces with the interface type of the physical routing interface through the ACL module.

In one embodiment, the apparatus further includes:
performing, by the switch, layer 3 forwarding on the message in response to the port number on the switch being consistent with the message destination MAC address corresponding to the message to be forwarded; and
performing, by the switch, layer 2 forwarding on the message in response to the port number on the switch being inconsistent with the message destination MAC address corresponding to the message to be forwarded.

In one embodiment, the apparatus further includes:
determining a relationship between a message virtual local area network (VLAN) corresponding to the message to be forwarded and the message destination MAC address, and determining the forwarding type of the message in response to adding the one or more routing interfaces with the interface type of the virtual routing interface through the ACL module.

In one embodiment, the apparatus further includes:
performing, by the switch, layer 3 forwarding on the message in response to the message VLAN corresponding to the message to be forwarded being consistent with the message destination MAC address; and
performing, by the switch, layer 2 forwarding on the message in response to the message VLAN corresponding to the message to be forwarded being inconsistent with the message destination MAC address.

In one embodiment, the switch includes software for controlling hardware in the switch, and the apparatus further includes:
issuing, by the software, the routing MAC address management table to the hardware in response to adding the one or more routing interfaces; and
creating, by the software, an ACL table for the ACL module and issuing to the hardware, and creating a soft linked list in response to the hardware table entry resources of the routing MAC address management table not meeting the preset number of routing interfaces.

In one embodiment, the apparatus further includes:
confirming whether routing MAC addresses of the one or more routing interfaces to be deleted are stored in the ACL table according to the soft linked list to obtain a matching result in response to deleting the one or more routing interfaces; and
processing the one or more routing interfaces according to the matching result.

In one embodiment, the apparatus further includes:
deleting the soft linked list corresponding to the ACL table in response to the routing MAC addresses of the one or more routing interfaces to be deleted being stored in the ACL table; and
searching the routing MAC addresses of the one or more routing interfaces to be deleted from the routing MAC address management table to delete the routing MAC addresses of the one or more routing interfaces in response to the routing MAC addresses of the one or more routing interfaces to be deleted being not stored in the ACL table.

In one embodiment, the apparatus further includes:
transferring a header of the soft linked list corresponding to the ACL table to the routing MAC address management table in response to deleting the routing MAC addresses of the one or more routing interfaces.

The apparatus embodiments are substantially similar to the method embodiments, and thus the description is relatively simple, and the relevant points can be found in part of the description of the method embodiments.

In addition, an embodiment of the present disclosure further provides an electronic device, including: a processor, a memory and a computer program stored in the memory and executable on the processor, where the computer program, when executed by the processor, causes the processor to implement various processes of the above method for managing routing MAC addresses in the foregoing embodiments, and can achieve the same technical effects. To avoid repetition, details are not described herein again.

FIG. 5 is a schematic structural diagram of a computer non-transitory readable storage medium provided in an embodiment of the present disclosure.

The embodiment of the present disclosure further provides a computer non-transitory readable storage medium 501, on which a computer program is stored, where the computer program, when executed by a processor, causes the processor to implement various processes of the above method for managing routing MAC addresses in the foregoing embodiments, and can achieve the same technical effects. To avoid repetition, details are not described herein again. For example, the computer non-transitory readable storage medium 501 includes a read-only memory (ROM), a random access memory (RAM), a magnetic disk, an optical disc, or the like.

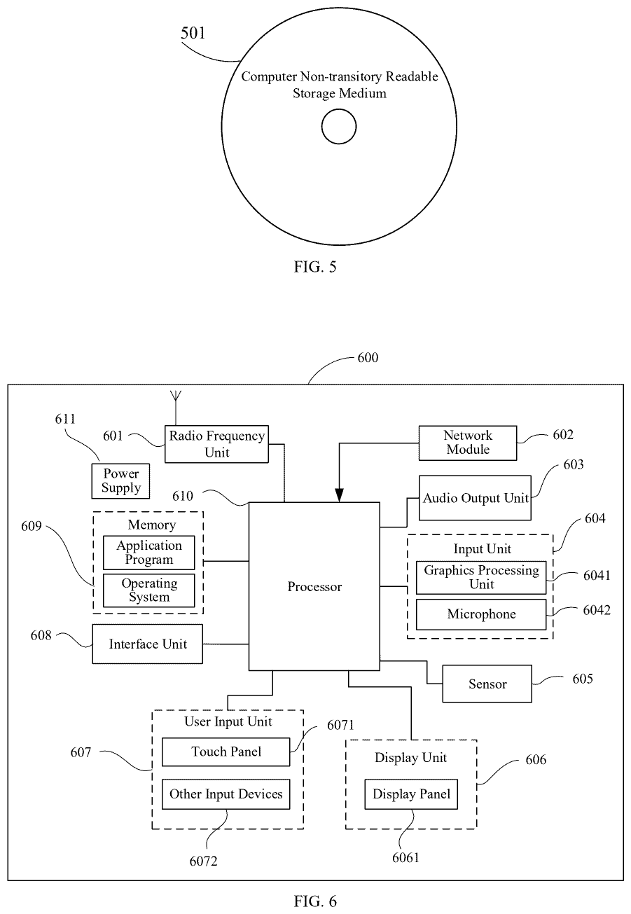

FIG. 6 is a schematic diagram of a hardware structure of an electronic device for implementing various embodiments of the present disclosure.

The electronic device 600 includes but is not limited to a radio frequency unit 601, a network module 602, an audio output unit 603, an input unit 604, a sensor 605, a display unit 606, a user input unit 607, an interface unit 608, a memory 609, a processor 610 and a power supply 611. It can be understood by a person skilled in the art that the structure of the electronic device involved in the embodiments of the present disclosure does not constitute a limitation on the electronic device, and the electronic device can include more or less components than shown in the drawings, or combine some components, or arrange different components. In the embodiments of the present disclosure, the electronic device includes but is not limited to a mobile phone, a tablet computer, a notebook computer, a palmtop computer, a vehicle-mounted terminal, a wearable device, a pedometer, or the like.

It should be understood that in the embodiments of the present disclosure, the radio frequency unit 601 may be configured to receive and transmit information, or to receive and transmit a signal in a call process, and specially, after receiving downlink data from a base station, transmit the downlink data to the processor 610 for processing; and also transmit uplink data to the base station. Generally, the radio frequency unit 601 includes but is not limited to an antenna, at least one amplifier, a transceiver, a coupler, a low noise amplifier, a duplexer, and the like. In addition, the radio frequency unit 601 may also communicate with a network and other devices via a wireless communications system.

The electronic device provides wireless broadband Internet access for a user by using the network module 602, for example, helping the user send and receive e-mails, browse web pages, and access streaming media.

The audio output unit 603 may convert audio data received by the radio frequency unit 601 or the network module 602 or stored in the memory 609 into an audio signal and output the audio signal as a sound. In addition, the audio output unit 603 may further provide audio output (for example, a call signal received sound or a message received sound) related to a specific function performed by the electronic device 600. The audio output unit 603 includes a speaker, a buzzer, a telephone receiver, and the like.

The input unit 604 is configured to receive audio or video signals. The input unit 604 may include a graphics processing unit (GPU) 6041 and a microphone 6042. The graphics processing unit 6041 processes image data of a static picture or a video obtained by an image capture apparatus (for example, a camera) in a video capture mode or an image capture mode. A processed image frame may be displayed on the display unit 606. The image frame processed by the graphics processing unit 6041 may be stored in the memory 609 (or another storage medium) or transmitted via the radio frequency unit 601 or the network module 602. The microphone 6042 is capable of receiving sounds and processing such sounds into audio data. The processed audio data can be converted, in a telephone call mode, into a format that can be transmitted via the radio frequency unit 601 to a mobile communication base station.

The electronic device 600 further includes at least one sensor 605, for example, an optical sensor, a motion sensor, and other sensors. In the embodiments, the optical sensor includes an ambient light sensor and a proximity sensor. The ambient light sensor may adjust brightness of a display panel 6061 based on intensity of ambient light, and the proximity sensor may turn off the display panel 6061 and/or backlight when the electronic device 600 moves close to an ear. As a type of motion sensor, an accelerometer sensor can detect magnitudes of accelerations in all directions (usually three axes), can detect a magnitude and a direction of gravity when in a static state, and can be applied to posture recognition (for example, screen switching between portrait and landscape, related games, and magnetometer posture calibration) of the electronic device, functions related to vibration recognition (for example, a pedometer and tapping), and the like. The sensor 605 may also include a fingerprint sensor, a pressure sensor, an iris sensor, a molecular sensor, a gyroscope, a barometer, a hygrometer, a thermometer, an infrared sensor, and the like. Details are not described herein.

The display unit 606 is configured to display information input by the user or information provided to the user. The display unit 606 may include the display panel 6061. The display panel 6061 may be configured in a form of a liquid crystal display (LCD), an organic light-emitting diode (OLED), or the like.

The user input unit 607 may be configured to: receive input digit or character information and generate key signal input related to user settings and function control of the electronic device. In the embodiments, the user input unit 607 includes a touch panel 6071 and other input devices 6072. The touch panel 6071 is also referred to as a touchscreen, and may collect a touch operation of the user on or near the touch panel (for example, an operation performed on or near the touch panel 6071 by the user by using any appropriate object or accessory such as a finger or a stylus). The touch panel 6071 may include two parts: a touch detection apparatus and a touch controller. The touch detection apparatus detects a touch azimuth of a user, detects a signal brought by a touch operation, and transmits the signal to the touch controller. The touch controller receives touch information from the touch detection apparatus, converts the touch information into touchpoint coordinates, transmits the touchpoint coordinates to the processor 610, and can receive a command transmitted by the processor 610 and execute the command. In addition, the touch panel 6071 may be implemented in a plurality of forms, for example, as a resistive, a capacitive, an infrared, or a surface acoustic wave touch panel. The user input unit 607 may further include other input devices 6072 in addition to the touch panel 6071. In the embodiments, the other input devices 6072 may include but are not limited to a physical keyboard, a function button (for example, a volume button or a power on/off button), a trackball, a mouse, and a joystick. Details are not described herein.

Further, the touch panel 6071 may cover the display panel 6061. When detecting a touch operation on or near the touch panel 6071, the touch panel 6071 transmits the touch operation to the processor 610 to determine a type of a touch event. Then, the processor 610 provides a corresponding visual output on the display panel 6061 based on the type of the touch event. Although in FIG. 6, the touch panel 6071 and the display panel 6061 serve as two separate components to implement input and output functions of the electronic device, in some embodiments, the touch panel 6071 and the display panel 6061 may be integrated to implement the input and output functions of the electronic device, and this is not limited herein.

The interface unit 608 is an interface for connecting an external apparatus to the electronic device 600. For example, the external apparatus may include a wired or wireless headphone port, an external power supply (or battery charger) port, a wired or wireless data port, a memory card port, a port for connecting an apparatus with an identification module, an audio input/output (I/O) port, a video I/O port, a headset port, or the like. The interface unit 608 may be configured to receive an input (for example, data information or power) from an external apparatus and transmit the received input to one or more elements in the electronic device 600, or may be configured to transmit data between the electronic device 600 and the external apparatus.

The memory 609 may be configured to store software programs and various data. The memory 609 may mainly include a program storage area and a data storage area. The program storage area may store an operating system, an application program required for at least one function (for example, a sound play function and an image play function), and the like. The data storage area may store data created based on use of the mobile phone (for example, audio data and a phone book), and the like. In addition, the memory 609 may include a high-speed random access memory, or may further include a non-volatile memory, for example, at least one magnetic disk storage device, flash memory, or other volatile solid-state storage devices.

The processor 610 is a control center of the electronic device, uses various interfaces and lines to connect all parts of the entire electronic device, and performs various functions and data processing of the electronic device by running or executing the software program and/or module stored in the memory 609 and invoking data stored in the memory 609, thereby performing overall monitoring on the electronic device. The processor 610 may include one or more processing units. In some embodiments of the present disclosure, the processor 610 may integrate an application processor and a modem processor. The application processor mainly processes the operating system, a user interface, an application program, and the like. The modem processor mainly processes wireless communication. In some embodiments, it can be understood that the modem processor may be not integrated in the processor 610.

The electronic device 600 may further include a power supply 611 (for example, a battery) supplying power to the components. In some embodiments of the present disclosure, the power supply 611 may be logically connected to the processor 610 through a power management system, so that functions such as charge management, discharge management, and power consumption management are implemented by using the power management system.

In addition, the electronic device 600 includes some functional modules that are not shown. Details are not described herein.

It should be noted that in this specification, the terms “include” and “comprise”, or any of their variants are intended to cover a non-exclusive inclusion, such that a process, method, article, or apparatus that includes a list of elements not only includes those elements but also includes other elements that are not expressly listed, or further includes elements inherent to such process, method, article, or apparatus. In absence of more constraints, an element preceded by “includes a . . . ” does not preclude the existence of other identical elements in the process, method, article, or apparatus that includes the element.

According to the descriptions of the foregoing embodiments, a person skilled in the art can clearly understand that the method in the foregoing embodiments may be implemented by software in combination with a necessary general hardware platform. In some embodiments, the method in the foregoing embodiments may be implemented by hardware. However, in many situations, the former is an example implementation. Based on such an understanding, the technical solutions of the present disclosure essentially, or the part contributing to the related art may be implemented in a form of a software product. The computer software product is stored in a storage medium (for example, a ROM/RAM, a magnetic disk, or an optical disc), and includes several instructions for instructing a terminal (which may be a mobile phone, a computer, a server, an air conditioner, a network device, or the like) to perform the method described in the embodiments of the present disclosure.

The foregoing describes the embodiments of the present disclosure with reference to the accompanying drawings. However, the present disclosure is not limited to the foregoing specific embodiments. The foregoing specific embodiments are merely illustrative rather than restrictive. As instructed by the present disclosure, a person of ordinary skill in the art may develop many other manners without departing from principles of the present disclosure and the protection scope of the claims, and all such manners fall within the protection scope of the present disclosure.

A person of ordinary skill in the art may be aware that the various exemplary units and algorithm steps described in conjunction with the embodiments disclosed in the embodiments of the present disclosure can be implemented by electronic hardware, or a combination of computer software and electronic hardware. Whether the functions are executed by hardware or software depends on particular applications and design constraint conditions of the technical solutions. A person skilled in the art can use different methods to implement the described functions for every particular application, but it should not be considered that the implementation goes beyond the scope of the present disclosure.

It may be clearly understood by a person skilled in the art that, for the purpose of convenient and brief description, for a detailed working process of the foregoing system, apparatus, and unit, reference may be made to a corresponding process in the foregoing method embodiments, and details are not described herein again.

In the several embodiments provided in the present disclosure, it should be understood that the disclosed apparatus and method may be implemented in other manners. For example, the described apparatus embodiment is merely an example. For example, division into the units is merely logical function division and there may be other division in actual implementation. For example, a plurality of units or components may be combined or integrated into another system, or some features may be ignored or not performed. In addition, the displayed or discussed mutual couplings or direct couplings or communication connections may be implemented through some interfaces. The indirect couplings or communication connections between the apparatuses or units may be implemented in an electronic form, a mechanical form, or another form.

The units described as separate parts may or may not be physically separate, and parts displayed as units may or may not be physical units, and may be located at one position, or may be distributed on a plurality of network units. Some or all of the units may be selected based on actual requirements to achieve the objectives of the solutions of embodiments.

In addition, functional units in embodiments of the present disclosure may be integrated into one unit, or each of the units may exist alone physically, or two or more units may be integrated into one unit.

When the functions are implemented in the form of a software functional unit and sold or used as an independent product, the functions may be stored in a computer-readable storage medium. Based on such an understanding, the technical solutions of the present disclosure essentially, or the part contributing to the conventional technology, or some of the technical solutions may be implemented in a form of a computer software product. The computer software product is stored in a storage medium, and includes several instructions for instructing a computer device (which may be a personal computer, a server, a network device, or the like) to perform all or some of the steps of the method described in embodiments of the present disclosure. The storage medium may include but is not limited to any medium that can store program code, for example, a USB flash disk, a removable hard disk, a ROM, a RAM, a magnetic disk, or an optical disc.

The foregoing descriptions are merely specific implementations of the present disclosure, but are not intended to limit the protection scope of the present disclosure. Any variation or replacement readily figured out by a person skilled in the art within the technical scope disclosed in the present disclosure shall fall within the protection scope of the present disclosure. Therefore, the protection scope of the present disclosure shall be subject to the protection scope of the claims.

1. A method for managing routing media access control (MAC) addresses, applied to a switch, wherein the switch comprises a routing MAC address management table, the routing MAC address management table comprises hardware table entry resources, the hardware table entry resources of the routing MAC address management table are limited, and the hardware table entry resources correspond to routing interfaces, wherein the switch is provided with an access control list (ACL) module, the ACL module has a function of adding the routing interfaces, and the method comprises:
determining whether the hardware table entry resources of the routing MAC address management table meet a preset number of routing interfaces in response to an operation of configuring the routing interfaces;
adding a chip routing MAC address management table in response to the hardware table entry resources of the routing MAC address management table meeting the preset number of routing interfaces; and
adding one or more routing interfaces according to the ACL module in response to the hardware table entry resources of the routing MAC address management table not meeting the preset number of routing interfaces.

2. The method according to claim 1, wherein adding the one or more routing interfaces according to the ACL module in response to the hardware table entry resources of the routing MAC address management table not meeting the preset number of routing interfaces comprises:
determining an interface type of the routing interfaces; and
adding the one or more routing interfaces corresponding to the interface type according to the interface type.

3. The method according to claim 2, wherein the interface type of the routing interfaces comprises a physical routing interface, and adding the one or more routing interfaces corresponding to the interface type according to the interface type comprises:
adding the one or more routing interfaces with the interface type of the physical routing interface through the ACL module in response to the interface type of the routing interfaces being the physical routing interface.

4. The method according to claim 2, wherein the interface type of the routing interfaces comprises a virtual routing interface, and adding the one or more routing interfaces corresponding to the interface type according to the interface type comprises:
adding the one or more routing interfaces with the interface type of the virtual routing interface according to the interface type in response to the interface type of the routing interfaces being the virtual routing interface.

5. The method according to claim 1, wherein the switch is configured to forward a message, and a forwarding type of the message comprises layer 2 forwarding and layer 3 forwarding.

6. The method according to claim 5, wherein the routing MAC address management table on the switch is configured to determine whether the message is a valid layer 3 forwarding message.

7. The method according to claim 6, wherein the routing MAC address management table comprises routing MAC addresses, and the method further comprises:
determining the forwarding type of the message to perform corresponding forwarding on the message according to a relationship between the routing MAC addresses with a message destination MAC address corresponding to a message to be forwarded.

8. The method according to claim 7, wherein determining the forwarding type of the message to perform corresponding forwarding on the message according to the relationship between the routing MAC addresses with the message destination MAC address corresponding to the message to be forwarded comprises:
performing, by the switch, layer 3 forwarding on the message in response to the routing MAC address being consistent with the message destination MAC address corresponding to the message to be forwarded; and
performing, by the switch, layer 2 forwarding on the message in response to the routing MAC address being inconsistent with the message destination MAC address corresponding to the message to be forwarded.

9. The method according to claim 2, wherein the switch comprises an ingress port number, and the method further comprises:
determining a relationship between a port number on the switch and the message destination MAC address corresponding to the message to be forwarded, and determining the forwarding type of the message in response to adding the one or more routing interfaces with the interface type of the physical routing interface through the ACL module.

10. The method according to claim 9, wherein determining the relationship between the port number on the switch and the message destination MAC address corresponding to the message to be forwarded, and determining the forwarding type of the message in response to adding the one or more routing interfaces with the interface type of the physical routing interface through the ACL module comprises:
performing, by the switch, layer 3 forwarding on the message in response to the port number on the switch being consistent with the message destination MAC address corresponding to the message to be forwarded; and
performing, by the switch, layer 2 forwarding on the message in response to the port number on the switch being inconsistent with the message destination MAC address corresponding to the message to be forwarded.

11. The method according to claim 2, wherein the method further comprises:
determining a relationship between a message virtual local area network (VLAN) corresponding to the message to be forwarded and the message destination MAC address, and determining the forwarding type of the message in response to adding the one or more routing interfaces with the interface type of the virtual routing interface through the ACL module.

12. The method according to claim 11, wherein determining the relationship between a message virtual local area network (VLAN) corresponding to the message to be forwarded and the message destination MAC address, and determining the forwarding type of the message in response to adding the one or more routing interfaces with the interface type of the virtual routing interface through the ACL module comprises:
performing, by the switch, layer 3 forwarding on the message in response to the message VLAN corresponding to the message to be forwarded being consistent with the message destination MAC address; and
performing, by the switch, layer 2 forwarding on the message in response to the message VLAN corresponding to the message to be forwarded being inconsistent with the message destination MAC address.

13. The method according to claim 1, wherein the switch comprises software for controlling hardware in the switch, and the method further comprises:
issuing, by the software, the routing MAC address management table to the hardware in response to adding the one or more routing interfaces; and
creating, by the software, an ACL table for the ACL module and issuing to the hardware, and creating a soft linked list in response to the hardware table entry resources of the routing MAC address management table not meeting the preset number of routing interfaces.

14. The method according to claim 13, wherein the soft linked list is configured to manage the ACL table.

15. The method according to claim 13, wherein the method further comprises:
confirming whether routing MAC addresses of the one or more routing interfaces to be deleted are stored in the ACL table according to the soft linked list to obtain a matching result in response to deleting the one or more routing interfaces; and
processing the one or more routing interfaces according to the matching result.

16. The method according to claim 15, wherein processing the one or more routing interfaces according to the matching result comprises:
deleting the soft linked list corresponding to the ACL table in response to the routing MAC addresses of the one or more routing interfaces to be deleted being stored in the ACL table; and
searching the routing MAC addresses of the one or more routing interfaces to be deleted from the routing MAC address management table to delete the routing MAC addresses of the one or more routing interfaces in response to the routing MAC addresses of the one or more routing interfaces to be deleted being not stored in the ACL table.

17. The method according to claim 16, wherein the method further comprises:
transferring a header of the soft linked list corresponding to the ACL table to the routing MAC address management table in response to deleting the routing MAC addresses of the one or more routing interfaces.

18. The method according to claim 1, wherein each of the routing interfaces is an index in the routing MAC address management table, and the routing interface is in a one-to-one correspondence with the chip routing MAC address management table.

19. (canceled)

20. An electronic device, comprising: a processor, a communication interface, a memory and a communication bus, wherein the processor, the communication interface and the memory communicate with each other through the communication bus;
the memory is configured to store computer programs; and
the processor is configured to implement the method according to claim 1 when executing the computer programs stored on the memory.

21. A computer non-transitory readable storage medium having instructions stored thereon, wherein the instructions, when executed by one or more processors, cause the processors to perform the method according to claim 1.
